(19) United States
(12) Patent Application Publication
(10) Pub. No.: US 2014/0317940 A1
(43) Pub. Date: Oct. 30, 2014

(54) Anti-Stick Knife Blade

(71) Applicant: Michael A. N. Scobie, Kipawa (CA)

(72) Inventor: Michael A. N. Scobie, Kipawa (CA)

(21) Appl. No.: 14/262,385

(22) Filed: Apr. 25, 2014

Related U.S. Application Data
(60) Provisional application No. 61/815,929, filed on Apr. 25, 2013.

(51) Int. Cl. B26B 9/00

(52) U.S. Cl. CPC B26B 9/00
USPC 30/346

(57) ABSTRACT

An anti-stick kitchen knife blade consisting of a plurality of channels or scallops formed into the blade sides which begin at the top of the blade, along the spine of the blade, and continue towards the sharp edge of the blade, thereby providing an uninterrupted source of air between the knife blade sides and the material being cut. The channels or scallops end before reaching the blade edge. However, the air which is allowed to move within the scallops or channels helps to prevent a vacuum suction from being formed between the blade sides and the material during the action of cutting, regardless of the thickness of the material. This is especially effective for cutting moist materials such as fruits, vegetables and meats.

### FIELD OF THE INVENTION

The present invention relates to the field of knives, and in particular, relates to an anti-stick knife blade construction.

### BACKGROUND OF THE INVENTION

A number of previous inventions have been patented pertaining to the elimination of food adhesion to kitchen knives during the action of cutting and slicing. Also, various knife designs are commercially available which also seek to address this issue, including knives with semi-circular scalloped portions on their sides.

For example, Chinese patent publication No. 202137774 (Xuerong Wang) discloses an anti-adhesion kitchen knife blade having a plurality of concave areas (also referred to as grantons) along both sides of the blade close to the sharp edge. The limitation of the granton is that they are finite, closed concave impressions situated between the blade's spine and sharp edge. Consequently, during the cutting action, once the food passes beyond the top of the granton, a suction seal can still be formed, promoting the food to adhere to the blade.

These so-called “granton” edges are different from serrated edges since the scalloped portions appear only on the side of the knife blade, typically in an alternating fashion, and therefore, do not interfere with sharpening of the knife blade.

A similar knife design uses a “kullen” which has oval scallops on one or both sides of the blade; but these scallops are also placed above the blade edge, and beneath the blade spine.

Other designs include the use of non-stick films or coatings on the blade surfaces, or the use of a plurality of pits or bumps on the blade surface to minimize adhesion of the food to the blade.

For example, Chinese patent publication No. 201500988 (Ying Han) discloses a non-stick knife having a plurality of raised convex bumps on the blade sides for reducing the contact area between the blade and the material being sliced. The raised bumps force the material away from the blade during the action of slicing in order to break the suction seal. The limitation of this design is that except for the leading edge of the material being sliced, a suction seal can still exist between the blade (encompassing the bumps) and the material. This is especially true for soft materials such as meats and vegetables. Furthermore, this prior art relies on the raised bumps to push the material away from the blade, and therefore does not lead one skilled in the art to introduce an air source via channels to reduce suction force as described in the present invention.

Blades are also known which have holes which extend completely through the blade, but again, these holes are placed between the knife's sharp edge, and the knife blade spine.

While these knife designs do have some advantageous over a straight blade, they can still stick to food once the food passes beyond the top of the hole, granton, kullen, pits, or bumps, on the side of the blade.

To overcome these difficulties, it would be advantageous to provide a knife, and a knife blade in particular, which overcame these difficulties.

### SUMMARY OF THE INVENTION

Accordingly, it is a principal advantage of the present invention to provide a knife, and a knife blade in particular, which exhibits less adhesion to food when it is being cut by the knife blade.

The advantages set out hereinabove, as well as other objects and goals inherent thereto, are at least partially or fully provided by the knife and knife blade of the present invention, as set out herein below.

Accordingly, in one aspect, the present invention provides a knife blade comprising a sharp edge, side surfaces on either side of the blade, and a blade spine having a top edge, wherein the blade additionally comprises a plurality of channels or scallops on at least one side surface of the blade, which channels or scallops extend from a point above the sharp edge, to the top edge of the blade spine.

As such, the channels or scallops pass completely through the spine section, and are open to the top edge of the blade spine.

In a further aspect, the present invention also provides a knife comprising the knife blade described hereinabove.

### DETAILED DESCRIPTION OF THE INVENTION

In the present application, the term “scallop” refers to an opening on either or both sides of the knife blade. The scallop can be any suitable size or shape, but typically is oval at one end. The term channel is similar, and refers to any type of straight or curved groove or ridge that extends from part way up the knife blade, through the blade spine, and to the top of the knife blade.

Preferably, the channels are provided by a series of elongated concave channels which are provided on one or both sides of the blade starting at the blade spine and migrating downward towards the sharpened edge. The channels can be cut out of the blade, might also be provided by a series of raised ridges which extend downwardly from the blade spine.

As a result of the use of the scallops or elongated channels, an uninterrupted supply of air between the blade and the material being cut, is allowed, which reduces adhesion of the material to the blade during the action of slicing.

The scallops or channels can be on one side or on both sides of the blade. Preferably however, when the scallops or channels are on both sides of the blade, they are offset from one side of the blade to the other in order to maximize the blade thickness at any one point along the length of the blade.

The series of elongated channels can be arranged in an unlimited number of patterns. Possible patterns can include straight lines, curves, and can include interconnections where the channels joint or cross one another.

The scallops or channels can include a portion which passes entirely though the knife blade, so as to create an opening. However, it is preferred that the opening not extend through the spine, to the top of the blade, otherwise the strength of the blade can be adversely affected.

The present application is primarily directed to the use of knives, and therefore, the construction of the knife and the knife blade will otherwise be in accordance with normal knife production technology. For example, the knife blade itself is preferably made of steel, and most preferably, stainless steel. The handle section can be made from any suitable material, including wood, metal, ceramics, plastics, and the like, as is currently practiced.

However, the skilled artisan will be aware that the knife blades of the present invention can be used in a wide variety of application. Accordingly, while the present application will be hereinafter described with respect to one type of knife blade, the skilled artisan would be aware that the present application is equally applicable in any other knife, or knife blade application.

### BRIEF DESCRIPTION OF THE DRAWINGS

Embodiments of this invention will now be described by way of example only in association with the accompanying drawings in which:

FIGS. 1A and 1B are side views of two prior art knife designs;

FIG. 2 is a side view of a knife of the present invention;

FIG. 3 is a top view of a knife of the present invention;

FIG. 4 is a side view of a second embodiment of the present invention;

FIG. 5 is a side view of a further embodiment of the present invention;

FIGS. 6A and 6B are side views of still further embodiments of the present invention;

FIG. 7 is a perspective view of an even further embodiment of the present invention; and

FIG. 8 is a partial perspective view of an enlarged area of the knife of FIG. 7.

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example only. In the drawings, like reference numerals depict like elements.

It is expressly understood, however, that the drawings are for the purpose of illustration and description only and are not intended as a definition of the limits of the invention. Also, unless otherwise specifically noted, all of the features described herein may be combined with any of the above aspects, in any combination.

The present invention utilizes concave open air channels in the knife blade sides that ensure an uninterrupted supply of air between the blade sides and the material being sliced. The key to the uninterrupted air supply is that the channels pass through the spine, and are open at the top of the blade. As the blade passes through the material being sliced, the channels cannot be blocked regardless of the thickness of material being cut. This allows air to enter the channels thereby reducing the suction force that can be created between the blade sides and the material being sliced.

Channel patterns can include straight lines, curves, and interconnected channels. Certain patterns could be designed to optimize the cutting action of specific food types.

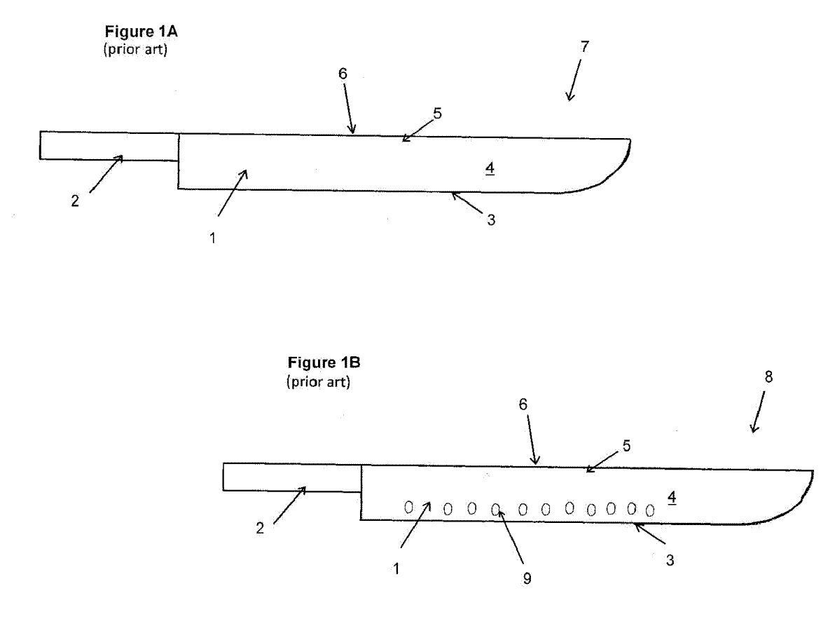

Referring to FIG. 1A, a prior art knife 7 is shown which includes a knife blade 1, and a handle 2. Knife blade 1 includes a sharp edge 3, a side section 4, and a blade spine 5 located at the top 6 of blade 1.

In FIG. 1B, a second prior art knife 8 is shown which includes a series of concave, oval cavities 9 (or “grantons”) on side sections 4B of blade 1B. Cavities 9 are placed on the side of blade 1 B, and do not extend to the knife edge 3B, or to the blade spine 5B.

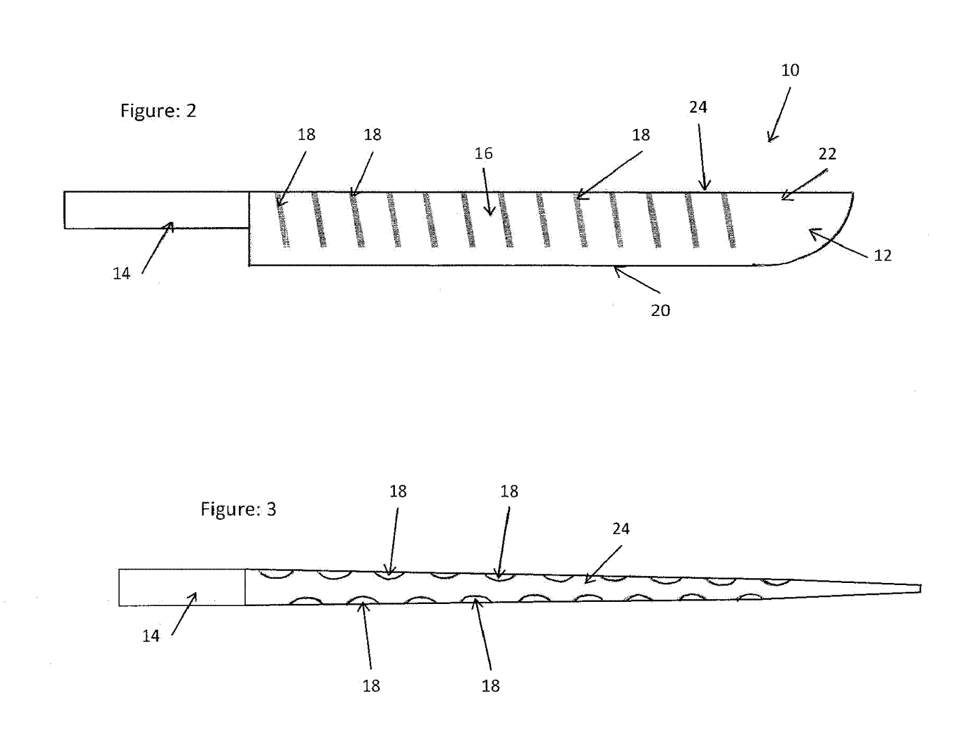

In FIG. 2, a knife 10 is shown having a blade 12 and a handle 14. On a side 16 of blade 12, a series of channels 18 are provided, which start at a point above sharp edge 20, and extend through blade spine 22 to the top 24 of blade 12.

Channels 18 are provided on each side 16 of blade 12 in an offset manner, as can be seen in FIG. 3. Channels 18 can have any appropriate size or shape, and as such, they can be square or rounded channels, or V-shaped grooves. The depth of the channel preferably less than 50% of the blade thickness, in order to maintain the strength of the blade. The width of the channel is preferably from 1 mm to 1.5 cm, but more preferably is between 2 mm and 7 mm. The width, and depth, of a given channel can vary, and different channels on the blade, can have different shapes and sizes.

From the top view of FIG. 3, the offset nature of channels 18 can be clearly seen in the top 24 of blade 12.

While linear, angled channels are shown in FIG. 3, the skilled artisan would be well aware that a variety of different shapes and sizes can be utilized. For example, in FIG. 4, another embodiment of a knife 30 is shown having a blade 32 and handle 34. Blade 32 includes a series of concave scallops 36 along one side of blade 32, which extend to the top 38 of blade 32. In this embodiment, the width of the channel increases so as to form a rounded scallop 36, on the side of blade 32.

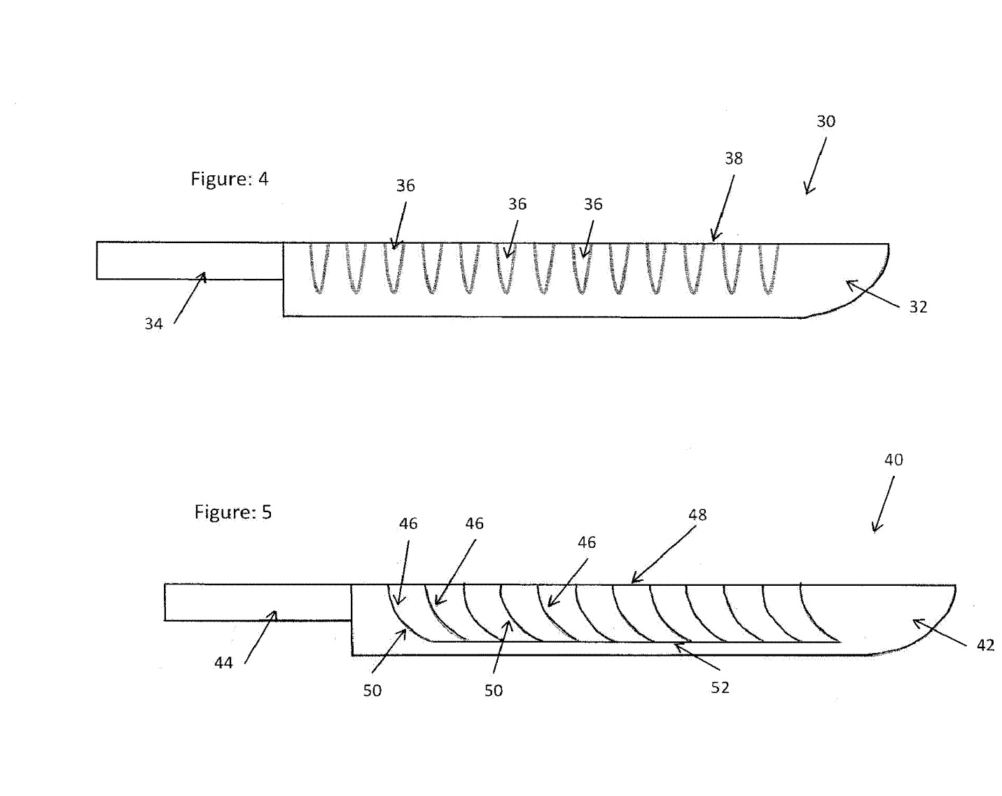

In FIG. 5, another embodiment of a knife 40 is shown having a blade 42 and handle 44. Blade 42 includes a series of curved channels 46 along the side of blade 42, which extend (at one end) to the top 48 of blade 42. Channels 46 provide a curved channel section 50, which meets a further horizontal channel 52. As such, all channels 46 are interconnected by channel section 52 to produce a blade 42 having a series of forward arching vertical curved channels 46 which are interconnected by a single horizontal channel 52 close to the sharpened edge of the blade.

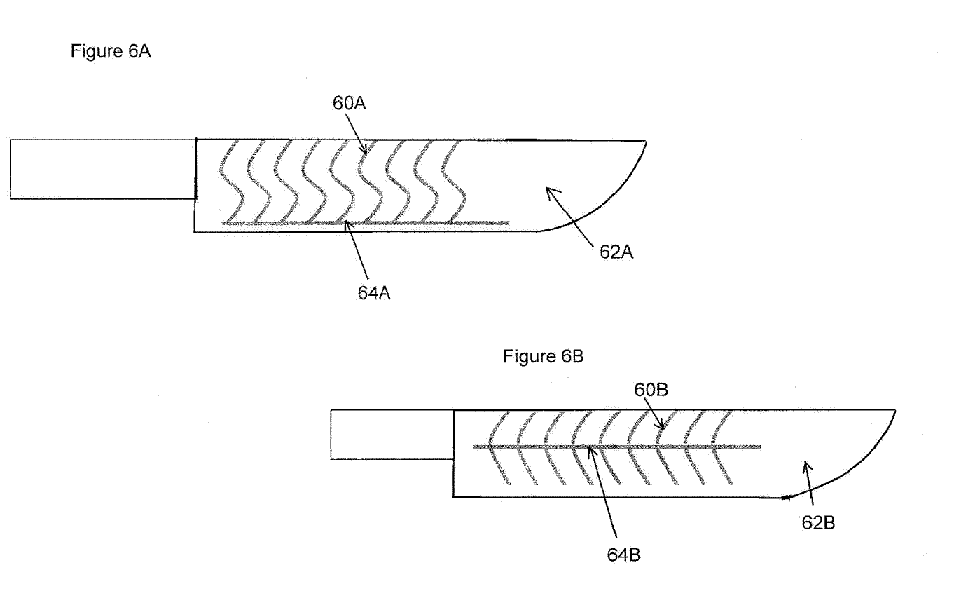

Other channel arrangements might also be used. For example, in FIGS. 6A and 6B, channels 60A and 60B are shown on blades 62A and 62B, respectively. Clearly, a variety of different shapes and sizes might be utilized. In FIG. 6A, an interconnecting channel 64A is shown near the edge of the blade. A similar interconnecting channel 64B is shown in FIG. 6B, wherein channel 64B is located in the middle of blade 62B. The position, shape and size of an interconnecting channel, when present, can vary.

Also, while the interconnecting channel can be the same size and shape as the other channels on the blade, it can be made larger or smaller, or can have a different profile or design.

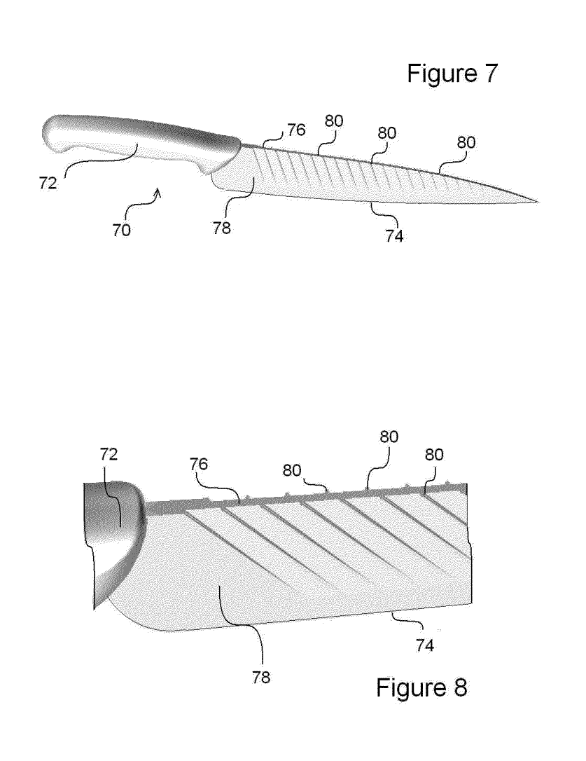

In FIGS. 7 and 8, a further embodiment of a knife 70 is shown having a handle 72, and a blade 78. Blade 78 has a sharp edge 74 and a blade spine 76. On each side of blade 78, a series of ridges 80, have been provided which extend inwardly from the blade spine 76 towards the centre of blade 78. The ridges 80 are best seen in FIG. 8, which shows an enlarged section of part of the handle 72 and blade 78 of knife 70. These ridges 80 create channel sections between the ridges 80, and thus provide the benefits of the blade channels extending to the blade spine, as previously discussed.

Thus, it is apparent that there has been provided, in accordance with the present invention, a knife and knife blade which fully satisfies the goals, objects, and advantages set forth hereinbefore. Therefore, having described specific embodiments of the present invention, it will be understood that alternatives, modifications and variations thereof may be suggested to those skilled in the art, and that it is intended that the present specification embrace all such alternatives, modifications and variations as fall within the scope of the appended claims.

Additionally, for clarity and unless otherwise stated, the word “comprise” and variations of the word such as “comprising” and “comprises”, when used in the description and claims of the present specification, is not intended to exclude other additives, components, integers or steps. Further, the invention illustratively disclosed herein suitably may be practiced in the absence of any element which is not specifically disclosed herein.

Moreover, words such as “substantially” or “essentially”, when used with an adjective or adverb is intended to enhance the scope of the particular characteristic; e.g., substantially planar is intended to mean planar, nearly planar and/or exhibiting characteristics associated with a planar element.

Further, use of the terms “up”, “down”, “upper” or “lower”, or the like, is intended to be considered in respect of the normal orientation of the device.

Also, while this discussion has addressed prior art known to the inventor, it is not an admission that all art discussed is citable against the present application.

What is claimed is:

1. A knife blade comprising a sharp edge, side surfaces on either side of the blade, and a blade spine having a top edge, wherein the blade additionally comprises a plurality of channels or scallops on at least one side surface of the blade, which channels or scallops extend from a point above the sharp edge, to the top edge of the blade spine.

2. A knife blade as claimed in claim 1 wherein said scallops or channels extend completely through the spine section, and are open to the top edge of the blade spine.

3. A knife blade as claimed in claim 1 wherein said channels are a series of elongated concave channels on the sides of the blade starting at the blade spine and migrating downward towards the sharpened edge.

4. A knife blade as claimed in claim 1 wherein said channels or scallops are located on both sides of the blade.

5. A knife blade as claimed in claim 4 wherein said channels or scallops are located on both sides of the blade and are offset from each other.

6. A knife blade as claimed in claim 1 wherein said channels are curved.

7. A knife blade as claimed in claim 1 wherein said channels are interconnected.

8. A knife blade as claimed in claim 1 wherein said channels are cut out of the blade.

9. A knife blade as claimed in claim 1 wherein said channels are formed by a series of raised ridges which extend downwardly from the blade spine

10. A knife comprising the knife blade as claimed in claim 1.
